(19) United States
(12) Patent Application Publication
(10) Pub. No.: US 2025/0081941 A1
(43) Pub. Date: Mar. 13, 2025

(54) APPARATUS AND METHOD FOR ANALYZING HERD BEHAVIOR PATTERNS OF VIDEO-BASED HERD OBJECTS

(71) Applicant: SEOUL NATIONAL UNIVERSITY R&DB FOUNDATION, Seoul (KR)

(72) Inventors: Joo Ho TAI, Seoul (KR); Gyu Jin JEONG, Seoul (KR); Yu Bin LEE, Seoul (KR); Ye Wan KIM, Seoul (KR); Jae Uk LIM, Seoul (KR); Dong Hwi BAE, Seoul (KR); Eun Seo OH, Seoul (KR); Woo Taek KIM, Seoul (KR)

(21) Appl. No.: 18/955,367

(22) Filed: Nov. 21, 2024

Related U.S. Application Data
(63) Continuation of application No. PCT/KR2023/006955, filed on May 23, 2023.

(30) Foreign Application Priority Data
May 23, 2022 (KR) 10-2022-0062996

(51) Int. Cl. A01K 29/00; G06N 3/08

(52) U.S. Cl. CPC A01K 29/005; G06N 3/08

(57) ABSTRACT

A herd behavior pattern analysis apparatus of video-based herd objects includes a data transmission/reception module; a memory that stores a herd pattern analysis program of the video-based herd objects; and a processor that executes the program stored in the memory, in which the program performs video pre-processing to detect an edge image of the herd object based on an input video captured through at least one camera allocated to a space where the herd objects are accommodated, and inputs the edge image into a herd pattern analysis model to detect pattern information of the herd object and to determine whether the herd object is normal based on the pattern information, and the herd pattern analysis model is a model learned using learning data including the edge image of each herd object, and outputs pattern information of the herd object based on the input video.

### CROSS-REFERENCE TO RELATED APPLICATION

This application is a Continuation of PCT Patent Application No. PCT/KR2023/006955, filed on May 23, 2023, which claims priority to Korean Patent Application No. 10-2022-0062996, filed in the Korean Intellectual Property Office on May 23, 2022, the entire contents of which are incorporated herein by reference.

### BACKGROUND

### 1. Field

The present disclosure relates to an apparatus and a method for analyzing herd behavior patterns of video-based herd objects.

### 2. Description of the Related Art

Previously, when an animal infectious disease was prevalent, abnormal behavior, posture, or changes in the appearance of individual animals were visually observed and confirmed to determine whether there was an abnormality. However, there were many difficulties in individually confirming the objects for the animal groups to be monitored.

In particular, these days, in the case of large-scale farms with a large number of herd objects, it is difficult to quickly respond to animal infectious diseases because too much effort and time are required to determine the status of each object.

In this regard, as an existing method for analyzing the movement patterns of livestock, Korean Patent Registration No. 10-1318716 (Title of the invention: System for analyzing movement patterns of cattle) discloses a configuration that analyzes the movement pattern of each livestock objects, reflects not only all movements that the livestock objects may take, but also changes in the movement pattern, thereby calculating an actual amount of the movement.

### SUMMARY

The present disclosure is intended to solve the above-mentioned problem, and an objective of the present disclosure is to determine whether objects included in a group are normal by monitoring characteristics of the group when several objects form a group.

However, a technical problem that the present embodiment aims to solve is not limited to the technical problem described above, and other technical problems may exist.

As technical means for solving the above-described technical problems, a herd behavior pattern analysis apparatus of video-based herd objects according to an embodiment of the present disclosure includes a data transmission/reception module; a memory that stores a herd pattern analysis program of the video-based herd objects; and a processor that executes the program stored in the memory, in which the program performs video pre-processing to detect an edge image of the herd object based on an input video captured through at least one camera allocated to a space where the herd objects are accommodated, and inputs the edge image into a herd pattern analysis model to detect pattern information of the herd object and to determine whether the herd object is normal based on the pattern information, and the herd pattern analysis model is a model learned using learning data including the edge image of each herd object, and outputs pattern information of the herd object based on the input video.

A method for analyzing herd behavior patterns using a herd behavior pattern analysis apparatus of video-based herd objects according to another embodiment of the present disclosure includes performing video pre-processing to detect an edge image of a herd object based on an input video captured through at least one camera allocated to a space where herd objects are accommodated; and inputting the edge image into a herd pattern analysis model to detect pattern information of the herd object and to determine whether the herd object is normal based on the pattern information, wherein the herd pattern analysis model is a model learned using learning data including the edge image of each herd object, and outputs pattern information of the herd object based on the input video.

According to one of the above-described problem solving means of the present application, it is possible to grasp the health status of an object only by identifying the arrangement and shape (pattern) of the objects forming the herd.

In addition, when a simple imaging device is introduced into existing equipment, it is possible to confirm whether objects have infectious diseases, other diseases, or changes in health and welfare through the herd behavior pattern analysis apparatus of the present disclosure.

In particular, the present disclosure has an effect of being able to respond very quickly to the spread of infectious diseases because it allows simultaneous observation of various objects.

In addition, since the present disclosure corresponds to a non-face-to-face/non-contact testing method, it is much safer than the prior art, and infectious diseases may be detected remotely at an early stage through constant monitoring, thereby providing a significant effect compared to the prior art.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram of an apparatus for analyzing herd behavior patterns of video-based herd objects according to an embodiment of the present disclosure;

FIG. 2 is a structural diagram of the herd behavior pattern analysis apparatus of the video-based herd objects for explaining a method for analyzing herd behavior patterns according to an embodiment of the present disclosure;

FIGS. 3A, 3B, and 4 are diagrams for explaining an image pre-processing method according to an embodiment of the present disclosure;

FIGS. 5A, 5B, 5C, 5D and 6 are diagrams for explaining pattern information about a normal state of a herd object according to an embodiment of the present disclosure;

FIGS. 7 and 8 are diagrams for explaining pattern information about an abnormal state of a herd object according to an embodiment of the present disclosure;

FIGS. 9A and 9B are a diagram illustrating a user interface according to an embodiment of the present disclosure; and

FIG. 10 is a flow chart illustrating a method for analyzing herd behavior patterns of video-based herd objects according to another embodiment of the present disclosure.

### DETAILED DESCRIPTION

Hereinafter, with reference to the attached drawings, embodiments of the present application will be described in detail so that those skilled in the art may easily implement them. However, the present application may be implemented in various different forms and is not limited to the embodiments described herein. In order to clearly explain the present application in the drawings, parts that are not related to the description are omitted, and similar parts are given similar reference numerals throughout the specification.

Throughout this specification, when a part is said to be “connected” to another part, this includes not only the case where it is “directly connected,” but also the case where it is “electrically connected” with another element therebetween.

Hereinafter, an embodiment of the present disclosure will be described in detail with reference to the attached drawings.

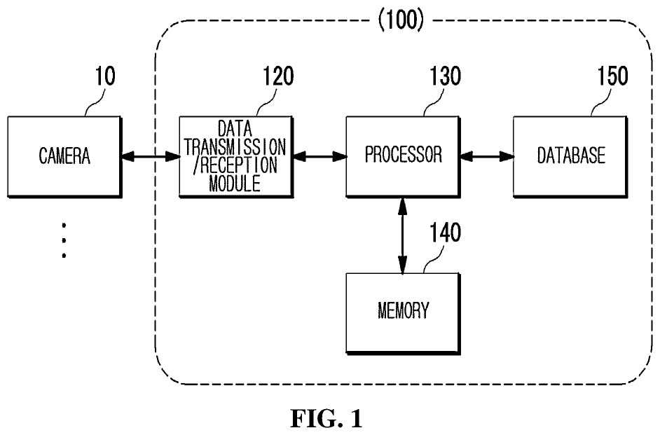

FIG. 1 is a configuration diagram of an apparatus for analyzing herd behavior patterns of video-based herd objects according to an embodiment of the present disclosure.

Hereinafter, the herd pattern referred to in the present disclosure refers to a behavioral pattern that appears during sleep around a feeding station of herd objects that act collectively without centralized instructions. The present disclosure is not limited to this, and the herd pattern includes not only the behavior patterns of the herd objects during sleeping, but also the individual behavior patterns of objects within the group while searching for food, eating, or drinking water.

As illustrated in FIG. 1, a herd behavior pattern analysis apparatus 100 of the video-based herd objects may include a plurality of cameras 10, a data transmission/reception module 120, a processor 130, a memory 140, and a database 150.

At least one camera 10 is allocated to a space where herd objects are accommodated, and may monitor each object. Additionally, the camera 10 may transmit a video captured at a predetermined view angle within a search area to the data transmission/reception module 120.

For example, the camera 10 includes a general CCTV camera that captures real imaging videos of the herd objects or a thermal imaging camera that captures the thermal imaging videos according to a temperature of the herd objects. Additionally, the camera 10 is not limited to this and includes a 3D depth camera that measures and analyzes TOF (time of flight) of light to calculate and display a distance to an object. Alternatively, it includes a LIDAR sensor camera that analyzes the distance and biological functions (for example, breathing and heart rate signals, and so on) by shooting a laser pulse and analyzing and measuring the time and characteristics that are reflected and returned.

The data transmission/reception module 120 may receive a video captured by the camera 10 at a predetermined view angle and transmit it to the processor 130.

The data transmission/reception module 120 may be a device that includes hardware and software necessary to transmit/receive signals such as control signals or data signals via wired or wireless connections with other network devices.

The processor 130 executes a program stored in the memory 140 and performs the following processing according to execution of a herd pattern analysis program of the video-based herd objects.

The program performs image pre-processing to detect edge images of herd objects based on input videos captured through at least one camera 10 allocated to the space where the herd objects are accommodated, and input the edge images into a herd pattern analysis model to detect pattern information of the herd objects, and determine whether the herd objects are normal based on the pattern information. At this time, the herd pattern analysis model is a model that is learned using the edge image of each herd object and learning data labeled with the pattern information of each herd object, or unlabeled learning data, and outputs the pattern information of the herd objects based on the input video. At this time, the edge image includes an outline of each herd object or an internal pattern of the herd object. Here, the internal pattern refers to various patterns that appear inside the edge and may include an outline pattern, a dot pattern, a corner pattern, a line pattern, or the like.

Therefore, the present disclosure may detect, very quickly and in real time, a suspected infectious disease-infected object within a space where the herd objects are accommodated. In particular, the present disclosure may provide an efficient herd object monitoring system with only a relatively low system construction cost.

The processor 130 may include all types of devices capable of processing data. For example, it, the processor 130, may refer to a data processing device built into hardware that has a physically structured circuit to perform a function expressed by code or instructions included in a program. An example of data processing device built into hardware may include a processing device such as microprocessor, central processing unit (CPU), processor core, multiprocessor, and application-specific integrated circuit (ASIC), or field programmable gate array (FPGA), but the scope of the present disclosure is not limited thereto.

The memory 140 stores the herd pattern analysis program of video-based herd objects. The memory 140 stores various types of data generated during the execution of an operating system for driving the herd behavior pattern analysis apparatus 100 of the video-based herd objects, or the herd pattern analysis program of video-based herd objects.

At this time, the memory 140 refers to a non-volatile storage device that continues to maintain stored information even when power is not supplied and a volatile storage device that requires power to maintain the stored information.

Additionally, the memory 140 may perform a function of temporarily or permanently storing data processed by the processor 130. Here, the memory 140 may include magnetic storage media or flash storage media in addition to the volatile storage device that requires power to maintain the stored information, but the scope of the present disclosure is limited thereto.

The database 150 stores or provides data necessary for the herd behavior pattern analysis apparatus 100 of the video-based herd objects under the control of the processor 130. As an example, the database 150 may store the edge image detected through a pre-processing process of an input image received from the camera 10 and the pattern information of the herd object detected by inputting the edge image into the herd pattern analysis model. The database 150 may be included as a separate component from the memory 140 or may be built in a partial area of the memory 140.

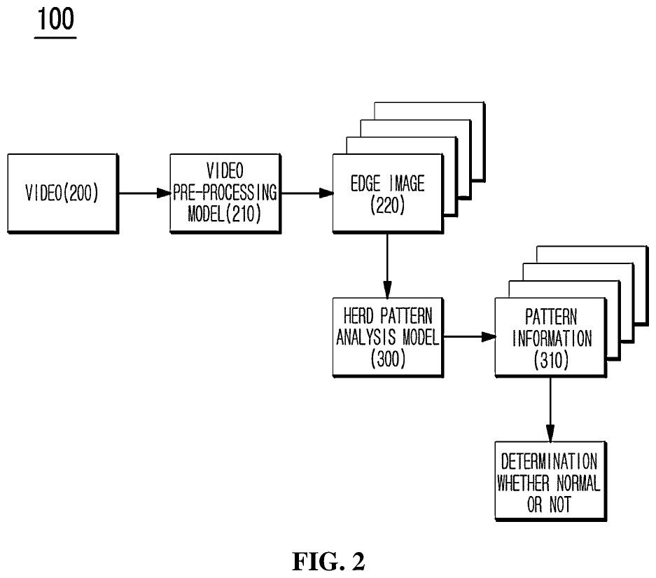

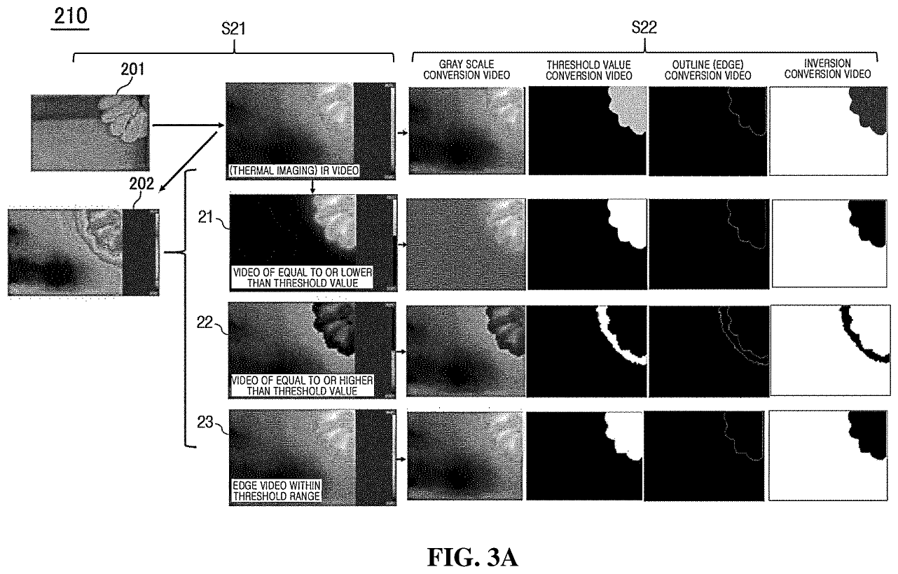

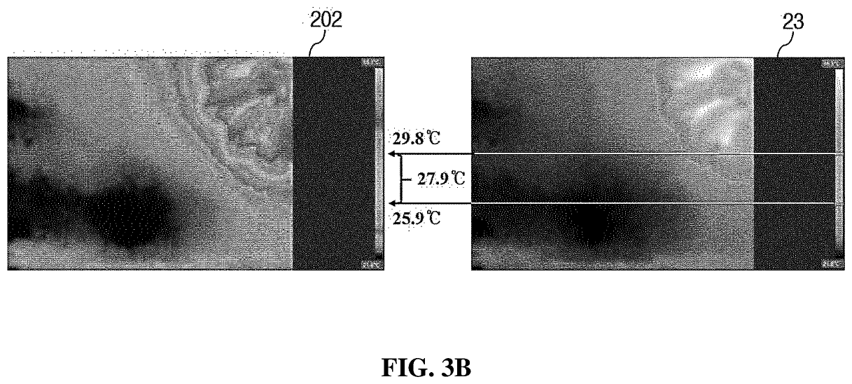

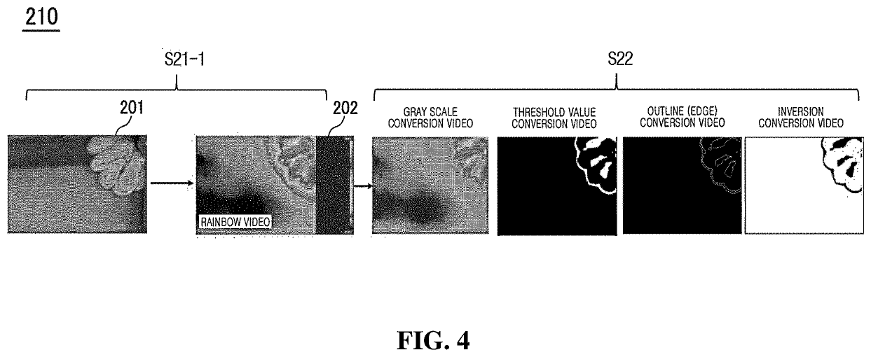

FIG. 2 is a structural diagram of the herd behavior pattern analysis apparatus of the video-based herd objects for explaining a method for analyzing herd behavior patterns according to an embodiment of the present disclosure, and FIGS. 3A, 3B, and 4 are diagrams for explaining an image pre-processing method according to an embodiment of the present disclosure.

Specifically, referring to FIG. 2, the herd behavior pattern analysis apparatus 100 of the video-based herd objects may execute a program including a video pre-processing model 210 and a herd pattern analysis model 300.

The video pre-processing model 210 may detect an edge image 220 of the herd objects based on the input video 20 captured through one or more cameras 10. At this time, the edge image 220 includes an outline of each herd object or an internal pattern of the outline. As an example, the camera 10 may collect videos taken in a top-down or bird view direction of each of the herd objects from an upper part of the space where each of the herd objects is accommodated. For example, when capturing a large breeding range such as a livestock pen, a center of the view angle may be captured as a top-down view, but the edge may be captured as a bird view. In this case, two or more cameras are placed to cover a large breeding range, and two or more images may be corrected/reconstructed and/or co-registered into one image to complement the bird view that appears at the edge.

For example, the input video 20 includes a real imaging video captured by a general CCTV camera, or a thermal imaging video displayed in black and white or color depending on a temperature difference between the background and the herd objects. Additionally, the present disclosure is not limited to this, and the input video 20 also includes a video captured by a 3D depth camera or a LIDAR sensor camera.

Referring to FIG. 3A, the video pre-processing model 210 converts the input video 20 into a thermal imaging video 202, and generates the input video 20 as a plurality of segmented images (21 to 23) based on a preset threshold range on the basis of the thermal video 202 (S21). Next, the segmented images 21 to 23 are converted to black and white images by black and white binarization, and then the black and white images are processed as difference videos to generate edge images 220 in which the outline of each herd object or the internal pattern of the outlines are identified (S22).

As another example, referring to FIG. 4, the video pre-processing model 210 may convert the input video 20 into the color thermal imaging video 202 (S21-1), and perform the black and white binarization on the color thermal imaging video 202 to convert it into the black and white image, and then process the black and white image as the difference video to generate the edge image 220 in which the outline of each herd object and internal pattern of the outline are identified (S22).

For example, the video pre-processing model 210 may be configured of a fusion form of techniques such as thermal imaging IR video segmentation and the OpenCV library. As a result, it is possible to solve a problem of shadows or noise that occurs when the existing binary video processing technique is applied singly, and generate the edge image 220 in which the herd boundary (outline) of the herd objects is accurately detected.

Specifically, in step S21, when the input video 20 is the real imaging video 201, the video pre-processing model 210 may convert the real imaging video 201 into the thermal imaging video 202 which is displayed in black and white or color according to the temperature difference between the background of the real imaging video 201 and the herd objects. However, when the input video 20 is the thermal imaging video 202 through the IR sensor, the thermal imaging conversion process is omitted.

Next, in step S21, the video pre-processing model 210 may generate the first to third segmented images 21 to 23 according to a threshold or threshold range set based on the temperature of the thermal imaging video 202.

Specifically, as illustrated in FIG. 3A, in step S21, when the temperature of the thermal imaging video 202 is equal to or lower than the preset threshold, the thermal imaging video 202 may be converted into the first segmented image 21 and when the temperature is equal to or higher than the preset threshold, the thermal imaging video 202 may be converted into the second segmented image 22. Additionally, when the temperature of the thermal imaging video 202 is within the preset threshold range, the thermal imaging video 202 may be converted into the third segmented image 23. That is, the first segmented image 21 is image segmentation of the background region and the object region based on the brightness indicating the temperature equal to or lower than the threshold in the thermal imaging video 202, the second segmented image 22 is image segmentation of the background region and the object region based on the brightness indicating the temperature equal to or higher than the threshold in the thermal imaging video 202, and the third segmented image 23 is image segmentation of the background region and the object region based on the brightness indicating the temperature in the threshold region in the thermal imaging video 202.

For example, in the case of the herd objects are livestock such as pigs, there is a significant difference between the body temperature of the herd objects and the temperature of the floor where the herd objects are accommodated. Therefore, the threshold and the threshold range may be set based on the temperature difference of the thermal imaging video 202, and the first to third segmented images 21 to 23 may be generated. For example, as illustrated in FIG. 3B, under environmental/temperature/humidity conditions where the lowest floor temperature is 21.8° C. and the highest body surface temperature of the pig is 36.3° C., the threshold region is 29.8° C. to 25.9° C., and the threshold value of the average temperature (27.9° C.), the maximum value (29.8° C.) or the minimum value (25.9° C.) may be used as a standard depending on the experiment.

For example, in the case of the black and white thermal imaging video, the process of generating the segmented images 21 to 23 is omitted in step S21, and the black and white thermal imaging video is binarized and converted to the black and white image in step S22, and then the difference video is processed to detect the edge image 220 of the herd object. As another example, in the case of the color thermal imaging video, the first to third segmented images 21 to 23 may be generated in step S21 based on a difference in color or difference in brightness indicating a difference in temperature in the color thermal imaging video.

Thereafter, in step S22, the video pre-processing model 210 performs black and white binarization on each of the first to third segmented images 21 to 23 and then processes the black and white image into the difference video to detect the edge image 220 in which the outline of the herd object or the internal pattern of the outline.

At this time, the edge image 220 is a difference video image in which only herd objects are extracted from the background, and may include a threshold difference video, an outline (edge) difference video, and an inversion difference video. This difference video processing process extracts the pattern of herd objects according to the difference in brightness of the black and white image, and the edge image 220 includes an image which is generated by using existing difference video processing techniques including line extraction, residual, emphasis, simplification extraction, and the like.

Referring again to FIG. 2, the herd pattern analysis model 300 may input the edge image detected from the video pre-processing model 210 into the herd pattern analysis model 300 to detect pattern information of each herd object.

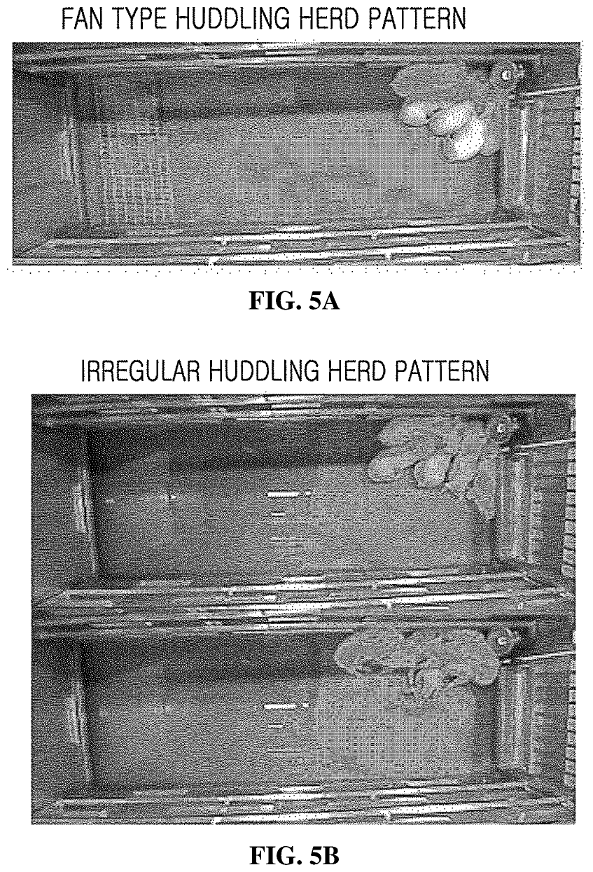

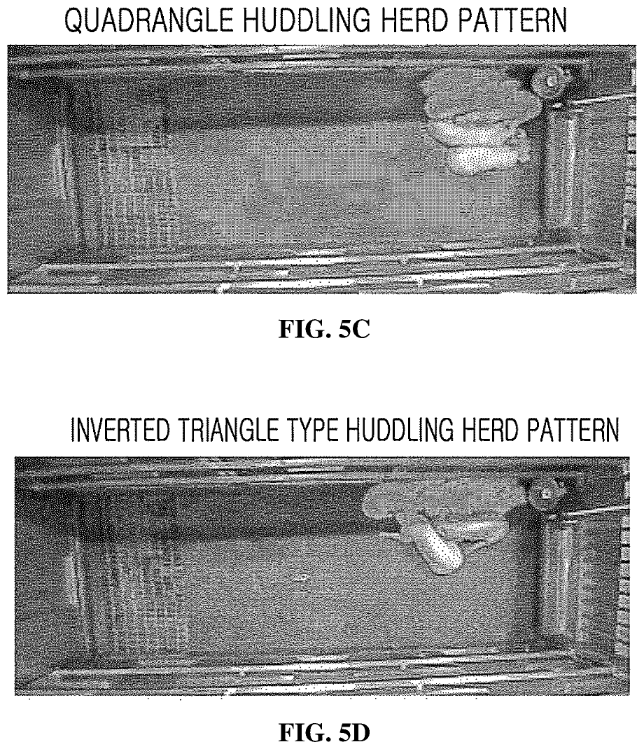

The herd pattern analysis model 300 may be built according to a supervised learning method using learning data labeling the pattern information of each herd object with respect to the edge image 220 of each herd object. At this time, the learning network may include various architectures such as R (Region)-CNN, YOLO (You Look Only Once), and SSD (Single Shot Detector). At this time, detailed description of the pattern information will be described later with reference to FIGS. 5A to 8.

In another embodiment, the herd pattern analysis model 300 may be an unsupervised learning model grouping the patterns of herd objects based on the edge image 220 of each herd object. For example, the herd pattern analysis model 300 may be implemented as principal component analysis (PCA), K-means clustering model, DBSCAN clustering model, affinity propagation clustering model, hierarchical clustering model, a spectral clustering model, and the like.

As an example, the herd pattern analysis model 300 includes a herd algorithm based on the unsupervised learning model in which a representative still image, where each herd object remains stationary for a predetermined time, is selected and pattern information of each herd object is detected based on the selected representative still image. At this time, the pattern information of each herd object may be classified based on the similarity of the edge image corresponding to the representative still image with each cluster. For example, in the case of a pig herd, the representative still image may include resting states such as sleeping, sitting, and lying down, as well as states such as searching for food and drinking/eating.

The herd behavior pattern analysis apparatus 100 may input the edge image 220 into the herd pattern analysis model 300 to detect the pattern information of the herd objects and determine whether the herd objects are normal based on the pattern information. At this time, the herd behavior pattern analysis apparatus 100 may provide the input video 20 of each herd object captured in real time as well as pattern information and normality of each herd object. Additionally, when unlearned pattern information is detected by the herd pattern analysis model 300, it may be determined to be a herd object in an abnormal state.

In one embodiment, the herd behavior pattern analysis apparatus 100 inputs the edge image 220 into the herd pattern analysis model 300 to obtain pattern information of the herd objects, and may determine whether the herd object is in the normal or abnormal state based on the distribution of the pattern information accumulated over a certain period of time. The pattern information may refer to not only labeled pattern classification information about the herd patterns, but also unlabeled pattern group information.

In another embodiment, the herd pattern analysis model 300 includes an outlier detection algorithm that detects the abnormal herd using pattern information of detected herd objects as input and detects normal and abnormal patterns based on the detected abnormal herd. Additionally, the herd pattern analysis model 300 may generate the pattern information of the herd objects each classified into the normal pattern and the abnormal pattern as a tree structure according to frequency.

Additionally, the herd behavior pattern analysis apparatus 100 may provide a user interface that displays the normal state of the herd objects and the frequency of each pattern information in a tree map based on the generated tree structure. For example, the outlier detection algorithm includes at least one of Principal Component Analysis (PCA), Fast-MCD, Isolation Forest, Local Outlier Factors (LOF), and one-class SVM, K-means, Hierarchical Clustering Analysis (HCA), and DBSCAN.

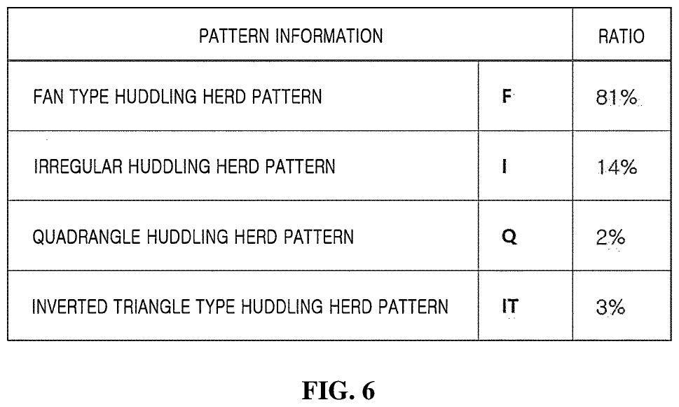

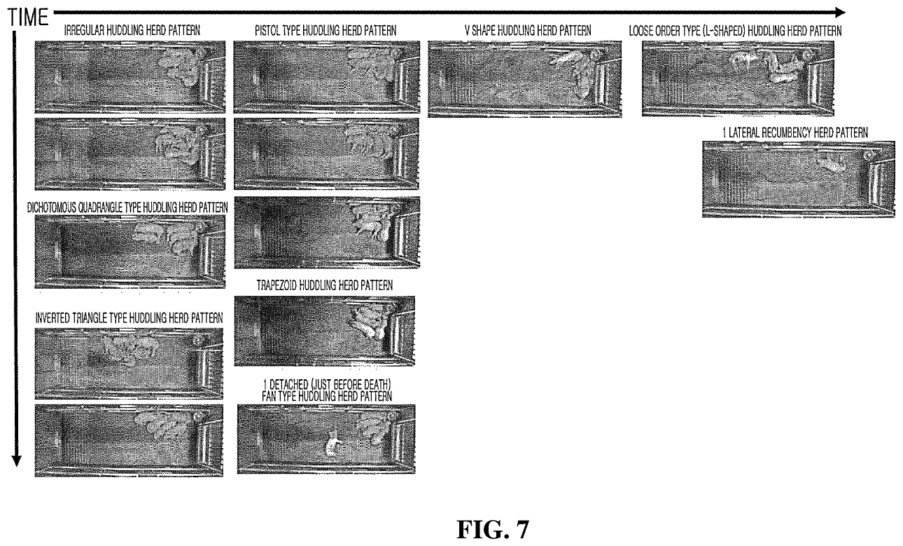

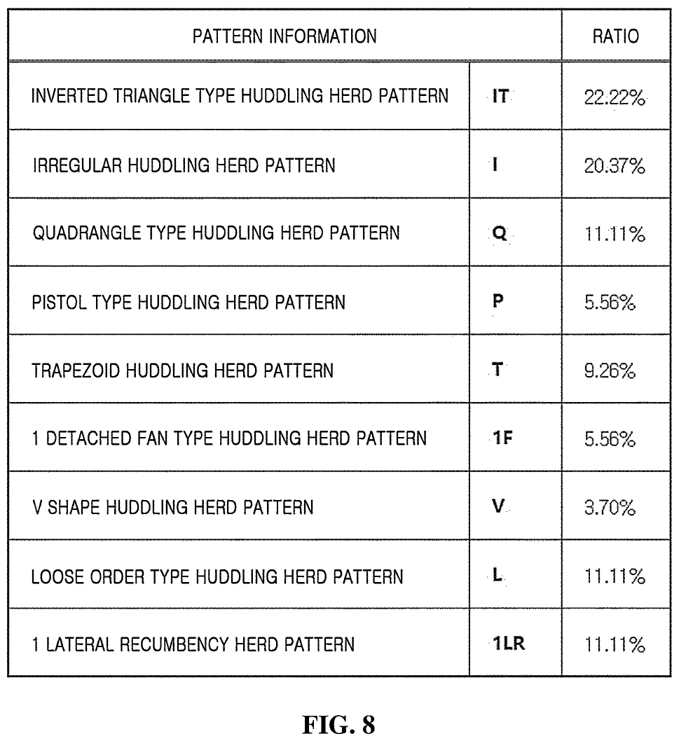

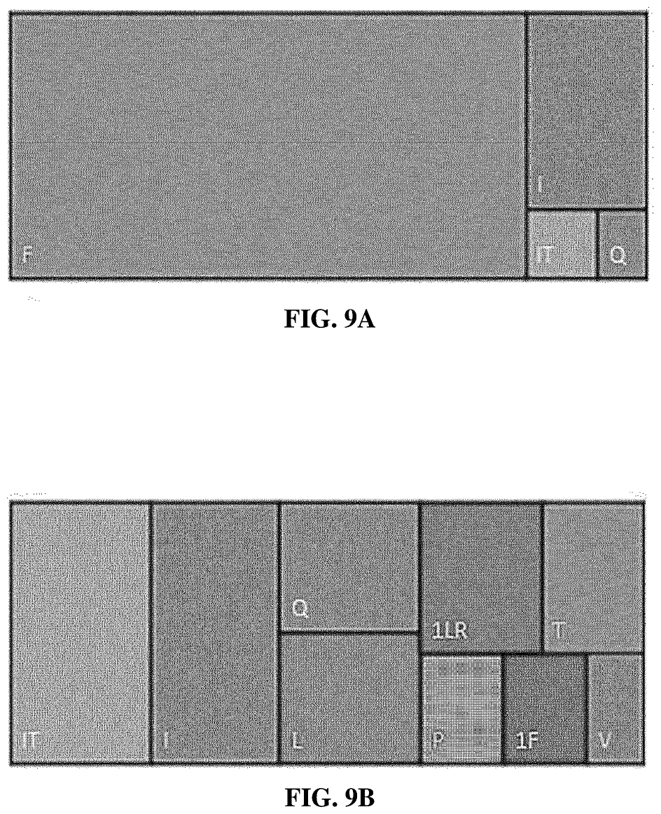

FIGS. 5A, 5B, 5C, 5D and 6 are diagrams for explaining the pattern information about the normal state of the herd object according to an embodiment of the present disclosure, FIGS. 7 and 8 are diagrams for explaining the pattern information about the abnormal state of the herd object according to an embodiment of the present disclosure, and FIGS. 9A and 9B are a diagram illustrating the user interface according to an embodiment of the present disclosure.

First, referring to FIGS. 9A and 9B, the program may classify herd objects into normal or abnormal patterns depending on whether they are normal or not, and provide the user interface that outputs the frequency of each pattern information classified as the normal and abnormal patterns. Specifically, the user interface may provide the pattern information of each herd object in the form of a map divided by each pattern information within a screen of a predetermined area. Each pattern information may be displayed as an area proportional to the frequency within the corresponding normal or abnormal pattern. At this time, the rectangular tree map shape illustrated in black and white in FIGS. 9A and 9B are only an example, and may include various shapes in which the area is divided according to the ratio of each pattern information within a predetermined area. Each pattern information may be expressed in color as well as black and white with different brightness. In addition, an interface may be used to display the classification results of each pattern by applying various clustering methods (for example, t-SNE, and so on).

As illustrated in FIGS. 6 and 9A, in the case of the normal huddling herd pattern, the number of types of pattern information is equal to or lower than half that of the abnormal huddling herd pattern illustrated in FIG. 9B. Additionally, the pattern information with the highest frequency displayed on the user interface appears to occupy a larger area than that of the rest of the pattern information combined. As illustrated in FIGS. 8 and 9B, in the case of the abnormal huddling herd pattern, there are many types of pattern information classified in the herd, and the ratios of areas for each pattern information displayed on the user interface are similar to each other.

Hereinafter, the pattern information of herd objects will be described with reference to FIGS. 5A to 8. Here, pig is described as an example of the herd object, but the herd object of the present disclosure is not limited to livestock and includes various types of animals including insects.

The pattern information may include the edge image 220 detected by monitoring herd objects in the normal state and labeled learning data. For example, in the case of a pig herd, a disposition form of pigs lying down to sleep around a drinking fountain in a barn may be learned as the pattern information.

FIGS. 5A to 5D are a video of representative sleeping posture patterns of the normal pig herd monitored for 15 to 20 minutes per day for about 30 days, and FIG. 6 illustrates a table illustrating the ratio of each sleeping posture pattern.

As illustrated in FIGS. 5A to 5D, the case of the pig herd, the pattern information includes fan type huddling herd pattern, irregular huddling herd pattern, quadrangle type huddling herd pattern, and inversed triangle type huddling herd pattern, and in the normal pig herd, the fan type huddling herd pattern was the highest at equal to or higher than 80%. At this time, the huddling herd pattern indicates a state in which objects are crouching or huddling together.

FIG. 7 illustrates representative sleeping posture patterns of experimental pig herds (abnormal pig herds) infected with African swine fever virus (ASFv) according to time series changes, and is a video monitored for 15 to 20 minutes per day during the survival period of about 15 days, and FIG. 8 illustrates a table illustrating the ratio of each sleeping posture pattern.

As illustrated in FIGS. 7 and 8, the pattern information may include inverted triangle type huddling herd pattern, irregular huddling herd pattern, quadrangle type huddling herd pattern, pistol type huddling herd pattern, trapezoid huddling herd pattern, 1 detached fan type huddling herd pattern, v shape huddling herd pattern, loose order type huddling herd pattern, and 1 lateral recumbency herd pattern. As the pig herd maintaining normal state, such as the irregular huddling herd pattern, quadrangle type herd pattern, and inverted triangle type huddling herd pattern reached the abnormal state over time, the pig herd illustrates pistol type huddling herd pattern, trapezoid huddling herd pattern, or so on. At this time, the inverted triangle type huddling herd pattern and the irregular huddling herd pattern each account for equal to or more than 20%, and the quadrangle type huddling herd pattern accounts for equal to or more than 10%. In other words, the normal state pattern accounts for equal to or more than half in the infected experimental pig herd. However, the quadrangle type huddling herd pattern and the inverted triangle type huddling herd pattern of the normal state also illustrate a dichotomous quadrangle type huddling herd pattern and the inverted triangle huddling herd pattern spaced apart from the drinking fountain, thereby illustrating abnormal signs of the pig herd. Afterwards, a herd just before death illustrates the pattern type (1 detached Fan type huddling herd pattern) in which at least one object separated from the herd, the V shape huddling herd pattern, and the loose order type huddling herd pattern.

For example, when the present disclosure is applied to the pig herd, the herd behavior pattern analysis apparatus 100 may detect the edge image 220 from the input video 20 that monitors the pig herd, and input the detected edge image 220 into the herd pattern analysis model 300 to detect the pattern information. At this time, in the extracted pattern information, when at least one of the fan type huddling herd pattern, the irregular huddling herd pattern, the quadrangle huddling herd pattern, and the inverted triangle type huddling herd pattern is detected in the ratio equal to or greater than the threshold (for example, 80%) of all, the pig herd may be determined to be in the normal state. On the other hand, when the extracted pattern information is the inverted triangle type huddling herd pattern, the loose order type huddling herd pattern, or a herd pattern in which at least one object is separated, or when unlearned pattern information is detected, the pig herd may be determined to be in the abnormal state. For example, the unlearned pattern information may mean that no one herd pattern in the extracted pattern information accounts for the ratio equal to or more than 25% of all herd patterns, and a plurality of detected individual herd patterns appear in similar ratio.

As a further embodiment, the present disclosure may define the total number of image frames of the input video per day as 1, set the weight for each time period (for example, morning, lunch or/and evening), and apply the weights to each pattern information, and thereby whether herd objects are normal is more accurately determined.

In another embodiment, in the present disclosure, time-series pattern information about the sleeping posture pattern of the pig herd according to a specific disease may be learned using learning data labeled as specific disease information such as African swine fever. Afterwards, when the time-series pattern information of the pig herd monitored through the input video 20 corresponds to pre-learned specific disease information, the specific disease information may be provided. Therefore, the present disclosure may confirm changes in the health of herd objects and the welfare of the herd through time-series changes in accumulated pattern information. It also provides the effect of managing various diseases of herd objects or all behaviors from the normal to abnormal states and early detection of infectious diseases.

Hereinafter, the description of the same configurations illustrated in FIGS. 1 to 9B will be omitted.

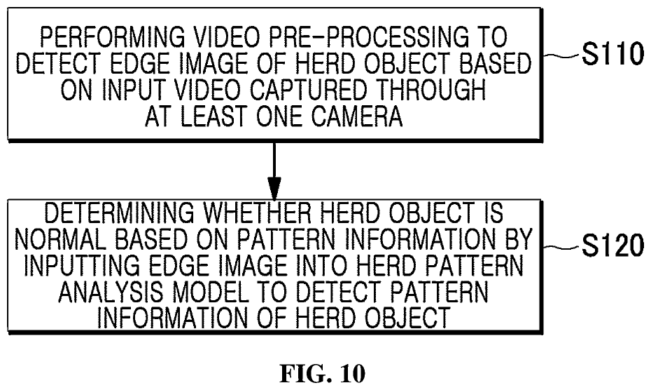

FIG. 10 is a flow chart illustrating a method for analyzing herd behavior patterns of video-based herd objects according to another embodiment of the present disclosure.

Referring to FIG. 10, the method for analyzing herd behavior patterns using a herd behavior pattern analysis apparatus of video-based herd objects according to another embodiment of the present disclosure includes a step of performing video pre-processing to detect the edge image 220 of the herd object based on the input video 20 captured through at least one camera 10 allocated to a space where the herd objects are accommodated (S110), and a step of inputting the edge image 220 into the herd pattern analysis model 300 to detect pattern information 310 of the herd object and to determine whether the herd object is normal based on the pattern information (S220). At this time, the herd pattern analysis model 300 is a model learned using learning data labeling the edge image 220 of each herd object and the pattern information 310 of each herd object, and outputs the pattern information 310 of the herd object based on the input video 20.

As an example, referring to FIG. 3A, step S110 includes a step of converting the input video 20 into the color thermal imaging video 202, and generating a plurality of segmented images from the input video based on a preset threshold range on the basis of the color thermal imaging video 202 (S21), and a step of performing black and white binarization on the segmented images to be converted into the black and white images, and processing the black and white images into the difference video to generate the edge image 220 in which the outline of each herd object or the internal pattern of the outline is identified (S22).

Specifically, step S21 includes a step of converting the thermal imaging video 202 into the first segmented image 21 when the temperature of the thermal imaging video 202 is equal to or lower than a preset threshold, a step of converting the thermal imaging video 202 into the second segmented image 22 when the temperature of the thermal imaging video 202 is equal to or higher than the preset threshold, and a step of converting the thermal imaging video 202 into the third segmented image 23 when the temperature of the thermal imaging video 202 is within the preset threshold range.

As another example, step S110 includes a step of converting the input image into the color thermal imaging video 202, and a step of performing black and white binarization on the color thermal imaging video 202 to be converted into the black and white image, and processing the black and white image into the difference video to generate the edge image 220 in which the outline of each herd object and the internal pattern of the outline are identified.

Step S120 includes a step of providing the input video 20 of each herd object captured in real time as well as the pattern information of each herd object and normality of each herd object, and determines the herd object as the abnormal state when unlearned pattern information is detected by the herd pattern analysis model 300.

Step S120 includes a step of providing the user interface that classifies the pattern into the normal pattern or the abnormal pattern depending on whether the herd object is normal or not, and outputs the frequency of each pattern information classified as the normal pattern and the abnormal pattern. At this time, the user interface may be provided in a diagrammatic form divided by the ratio of the area occupied by each pattern information within a screen of a certain area based on the frequency of each pattern information. As an example, the user interface may be in the form of the tree map as illustrated in FIGS. 9A and 9B, but is not limited to this, and may include a form in which an area of the drawing may be divided depending on the ratio of each pattern information within the area of various shapes such as a Venn diagram.

One embodiment of the present disclosure may also be implemented in the form of a recording medium containing instructions executable by a computer, such as program modules executed by a computer. Computer-readable media may be any available media that may be accessed by a computer and includes all of volatile and non-volatile media, removable and non-removable media. Additionally, computer-readable media may include computer storage media. Computer storage media includes all of volatile and non-volatile media, removable and non-removable media implemented in any method or technology for storage of information such as computer-readable instructions, data structures, program modules or other data.

Although the methods and systems of the present disclosure have been described with respect to specific embodiments, some or all of their components or operations may be implemented using a computer system having a general-purpose hardware architecture.

The description of the present application described above is for illustrative purposes, and those skilled in the art will understand that the present application may be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present application is indicated by the claims described below rather than the detailed description above, and all changes or modified forms derived from the meaning and scope of the claims and their equivalent concepts should be construed as being included in the scope of the present application.

What is claimed is:

1. A herd behavior pattern analysis apparatus of video-based herd objects, comprising:
a data transmission/reception module;
a memory that stores a herd pattern analysis program of the video-based herd objects; and
a processor that executes the program stored in the memory,
wherein the program performs video pre-processing to detect an edge image of the herd object based on an input video captured through at least one camera allocated to a space where the herd objects are accommodated, and determines whether the herd object is normal based on the pattern information by inputting the edge image into a herd pattern analysis model to detect pattern information of the herd object, and
the herd pattern analysis model is a model learned using learning data including the edge image of each herd object, and outputs pattern information of the herd object based on the input video.

2. The herd behavior pattern analysis apparatus of claim 1, wherein
the program generates a plurality of segmented images from the input video based on a preset threshold range on the basis of a thermal imaging video by converting the input video into the thermal imaging video in the video pre-processing, and generating an edge image in which an outline of each herd object or an internal pattern of the outline is identified by performing black and white binarization on the segmented images to be converted into a black and white images, and processes the black and white images into a difference video.

3. The herd behavior pattern analysis apparatus of claim 1, wherein
the program converts the input video into a color thermal imaging video in the video pre-processing, and generate an edge image in which an outline of each herd object or an internal pattern of the outline is identified by performing black and white binarization on the color thermal imaging video to be converted into a black and white images, and processes the black and white images into a difference video.

4. The herd behavior pattern analysis apparatus of claim 2, wherein
the program converts the thermal imaging video into a first segmented image when a temperature of the thermal imaging video is equal to or lower than a preset threshold, converts the thermal imaging video into a second segmented image when the temperature of the thermal imaging video is equal to or higher than the preset threshold, and converts the thermal imaging video into a third segmented image when the temperature of the thermal imaging video is within the preset threshold range.

5. The herd behavior pattern analysis apparatus of claim 1, wherein
the program provides an input video of each herd object captured in real time as well as pattern information of each herd object and normality of each herd object, and determines the herd object as an abnormal state when unlearned pattern information is detected by the herd pattern analysis model.

6. The herd behavior pattern analysis apparatus of claim 1, wherein
the program provides a user interface that classifies a pattern into a normal pattern or an abnormal pattern depending on whether the herd object is normal or not, and outputs the frequency of each pattern information classified as the normal pattern and the abnormal pattern, and
the user interface is provided in a diagrammatic form divided by a ratio of an area occupied by each pattern information within a screen of a certain area based on the frequency of each pattern information.

7. A herd behavior pattern analysis method using a herd behavior pattern analysis apparatus of video-based herd objects, the method comprising:
performing video pre-processing to detect an edge image of a herd object based on an input video captured through at least one camera allocated to a space where herd objects are accommodated; and
determining whether the herd object is normal based on the pattern information by inputting the edge image into a herd pattern analysis model to detect pattern information of the herd object,
wherein the herd pattern analysis model is a model learned using learning data including the edge image of each herd object, and outputs pattern information of the herd object based on the input video.

8. The herd behavior pattern analysis method of claim 7, wherein the performing of the video pre-processing includes:
generating a plurality of segmented images from the input video based on a preset threshold range on the basis of a thermal imaging video by converting the input video into the thermal imaging video; and
generating an edge image in which an outline of each herd object or an internal pattern of the outline is identified by performing black and white binarization on the segmented images to be converted into a black and white images, and processing the black and white images into a difference video.

9. The herd behavior pattern analysis method of claim 7, wherein the performing of the video pre-processing includes:
converting the input image into a color thermal imaging video in the video pre-processing; and
generating an edge image in which an outline of each herd object and an internal pattern of the outline are identified by performing black and white binarization on the color thermal imaging video to be converted into the black and white image, and processing the black and white image into a difference video.

10. The herd behavior pattern analysis method of claim 8, wherein the generating a plurality of segmented images includes:
converting the thermal imaging video into a first segmented image when a temperature of the thermal imaging video is equal to or lower than a preset threshold;
converting the thermal imaging video into a second segmented image when the temperature of the thermal imaging video is equal to or higher than the preset threshold; and
converting the thermal imaging video into a third segmented image when the temperature of the thermal imaging video is within the preset threshold range.

11. The herd behavior pattern analysis method of claim 7, wherein the determining whether the herd object is normal includes:
providing an input video of each herd object captured in real time as well as pattern information of each herd object and normality of each herd object; and
determining the herd object as an abnormal state when unlearned pattern information is detected by the herd pattern analysis model.

12. The herd behavior pattern analysis method of claim 7, wherein the determining whether the herd object is normal includes:
providing a user interface that classifies the pattern into the normal pattern or the abnormal pattern depending on whether the herd object is normal or not, and outputs a frequency of each pattern information classified as the normal pattern and the abnormal pattern, and
the user interface is provided in a diagrammatic form divided by a ratio of an area occupied by each pattern information within a screen of a certain area based on the frequency of each pattern information.
